(19) United States
(12) Patent Application Publication
(10) Pub. No.: US 2010/0082701 A1
(43) Pub. Date: Apr. 1, 2010

(54) System and Method for Using a Configuration Management Database

(75) Inventor: Nitin Maheshwari, Andhra Pradesh (IN)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/236,747

(22) Filed: Sep. 24, 2008

(51) Int. Cl. G06F 17/30

(52) U.S. Cl. 707/803; 707/E17.01

(57) ABSTRACT

A method comprises storing one or more configuration items in a local data cache, wherein a user may access the one or more configuration items from the local data cache without retrieving the one or more configuration items from a configuration management database. Modifications made, by the user, to the one or more configuration items are saved in the local data cache. The one or more modified configuration items may be uploaded to the configuration management database.

### TECHNICAL FIELD

The present disclosure relates generally to resource management, and more particularly to a system and method for using a configuration management database.

### BACKGROUND

Information systems are often made up of massive amounts of information and components. As such, information technology (IT) departments often rely on some repository to provide information relating to all of the components of the system. One method of accomplishing this is through the use of a configuration management database (CMDB). A CMDB can help an organization's IT department identify the content and relationship of the various configuration items (CI) that make up the CMDB. As information systems become increasingly large and complex, it may be desirable to maximize the efficiency of a CMDB for ease of use.

### SUMMARY OF EXAMPLE EMBODIMENTS

The present disclosure is directed to a system and method for using a configuration database. The teachings of the present disclosure may allow for a more efficient method of modifying or adding configuration items to a CMDB.

In accordance with a particular embodiment of the present disclosure, a method comprises storing one or more configuration items in a local data cache, wherein a user may access the one or more configuration items from the local data cache without retrieving the one or more configuration items from a configuration management database. The method further comprises saving modifications made by the user to the one or more configuration items in the local data cache and uploading the one or more modified configuration items to the configuration management database. According to particular embodiments, the method may further comprise presenting the one or more configuration items and relationships between the configuration items in a graphical display.

In accordance with another aspect of the present invention, a system comprises a local data cache that is operable to store one or more configuration items, wherein a user may access the one or more configuration items from the local data cache without retrieving the one or more configuration items from a configuration management database. The system further comprises a user interface operable to receive modifications, made by the user, to the one or more configuration items. The local data cache is operable to save the modifications made by the user, and the configuration management database is operable to receive one or more modified configuration items uploaded by the user.

In accordance with another aspect of the present invention, logic encoded in a computer readable medium is operable, when executed on a processor, to store one or more configuration items in a local data cache, wherein a user may access the one or more configuration items from the local data cache without retrieving the one or more configuration items from a configuration management database. The logic is further operable to save modifications made, by the user, to the one or more configuration items, in the local data cache and upload the one or more modified configuration items to the configuration management database.

Technical advantages of particular embodiments of the present disclosure include a system and method for storing one or more configuration items in a local data cache. This may allow for more efficient use of a CMDB, as a user may access frequently-used configuration items without having to search or browse the entire contents of the CMDB.

Further technical advantages of particular embodiments include a system and method for saving modifications to the configuration items in the local data cache. This may allow a user to work on a configuration item over a longer period of time, without committing any incomplete work to the CMDB production environment.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a schematic drawing illustrating a computer network configuration suitable for use within particular embodiments of the present disclosure;

FIG. 2 is a schematic diagram illustrating relationships between a CMDB and visualizer components, according to particular embodiments of the present disclosure;

FIG. 3 is a schematic diagram illustrating relationships between a CMDB and visualizer components, according to particular embodiments of the present disclosure;

FIG. 4 is a schematic drawing illustrating a CMDB graphical display format, according to particular embodiments of the present disclosure; and

FIG. 5 is a flow diagram illustrating a method for using a CMDB, according to particular embodiments of the present disclosure.

### DETAILED DESCRIPTION

Configuration management databases are made up of records referred to as configuration items (CIs). Configuration items may be a collection of objects related to the functionality of a system. These objects may include, but are not limited to files, code, requirements, or other documentation. These CIs often contain information about important attributes, as well as relationships among the various CIs. The CMDB may then be used to help an organization understand relationships between the CIs, track their arrangement, and monitor any changes made in the system. In many cases, a CMDB is able to automatically discover CIs or information about CIs. However, certain CIs may not be found using this auto-discovery, and may need to be added by a user.

In accordance with the teachings of the present disclosure, a system and method for using a configuration management database is disclosed. An object of the present disclosure is more efficient use of a CMDB and modification of the CIs within the CMDB.

According to particular embodiments of the present disclosure, a method comprises storing one or more configuration items in a local data cache, wherein a user may access the one or more configuration items from the local data cache without retrieving the one or more configuration items from a configuration management database. The method further comprises saving modifications made by the user to the one or more configuration items in the local data cache and uploading the one or more modified configuration items to the configuration management database. According to particular embodiments, the method may further comprise presenting the one or more configuration items and relationships between the configuration items in a graphical display format.

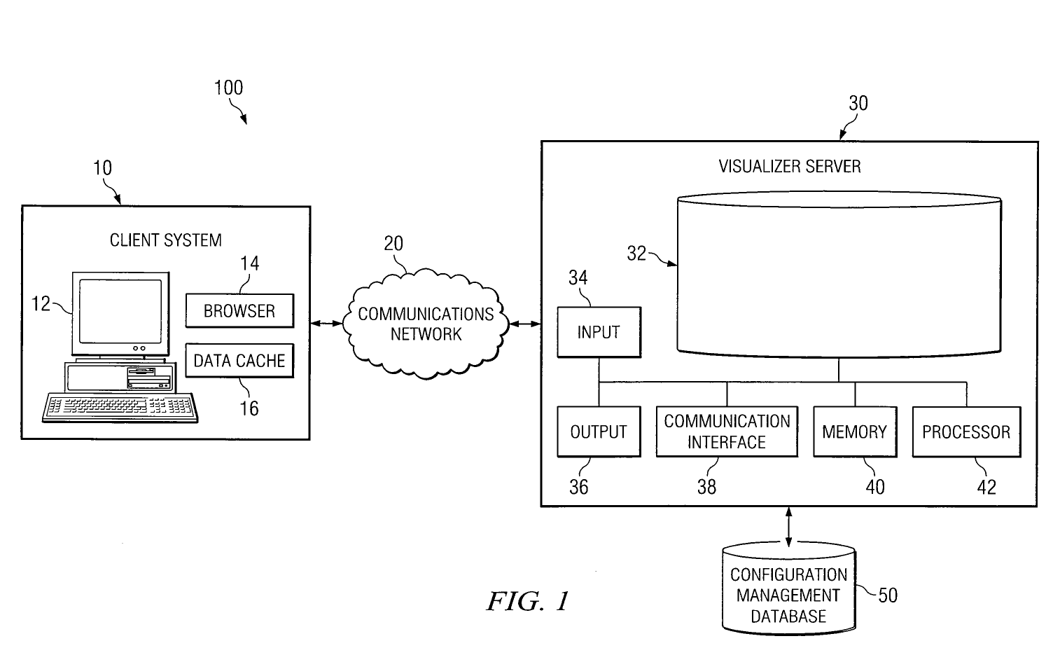

FIG. 1 illustrates a communications system, generally designated by reference numeral 100. Communications system 100 includes client system 10, communications network 20, visualizer server 30, and configuration management database 50.

Client system 10 includes a computer terminal 12, or other medium for accomplishing electronic communication. Terminal 12 may also include specific software, including a browser 14 that allows standardized communication with visualizer server 30. Terminal 12 may also include data storage, including local data cache 16, for storage of configuration items from a CMDB. Although the illustrated embodiment depicts client system 10 as a separate element, in alternative embodiments client system 10 may reside locally on server 30.

Visualizer server 30 may refer to any device that is operable to deliver information that is sent to the client system 10. According to the illustrated embodiment, server 30 includes storage device 32, an input device 34, an output device 36, a communication interface 38, a memory device 40, and a processor 42.

Input device 34 may refer to any suitable device that is operable to input, select, and/or manipulate various data and information. Input device 34 may include, for example, a keyboard, mouse, graphics tablet, joystick, light pen, microphone, scanner, or other suitable input device.

Output device 36 may refer to any suitable device that is operable for displaying information to a user. Output device 36 may include, for example, a video display, a printer, a plotter, or other suitable output device.

Communication interface 38 may refer to any suitable device that is operable to receive input for server 30, send output from server 30, perform suitable processing of the input or output or both, communicate to other devices, or any combination of the preceding. Communication interface 38 may include appropriate hardware (e.g. modem, network interface card, etc.) and software, including protocol conversion and data processing capabilities, to communicate through a LAN, WAN, or other communication system that allows server 30 to communicate to other devices. Communication interface 38 may include one or more ports, conversion software, or both.

Memory device 40 may refer to any suitable device operable to store and facilitate retrieval of data, and may comprise random access memory (RAM), read only memory (ROM), a magnetic drive, a digital video disk (DVD) drive, removable media storage, any other suitable data storage medium, or a combination of any of the preceding.

Processor 42 may refer to any suitable device operable to execute instructions and manipulate data to perform operations for server 30. Processor 42 may include, for example, any type of central processing unit (CPU).

Storage device 32 may refer to any suitable device operable for storing data and instructions. Storage device 32 may include, for example, a magnetic disk, flash memory, optical disk, or other suitable data storage device.

A configuration management database (CMDB) may be a database that contains relevant information about components used in an organization's IT services, as well as the relationships between those components. Configuration management database 50 may refer to any database conforming to this style. In the illustrated embodiment, CMDB 50 is positioned external to server 30. However, according to alternative embodiments, CMDB 50 may be located on client system 10, in storage device 32, or elsewhere on server 30. In particular embodiments, CMDB 50 may be accessed using a web-based application.

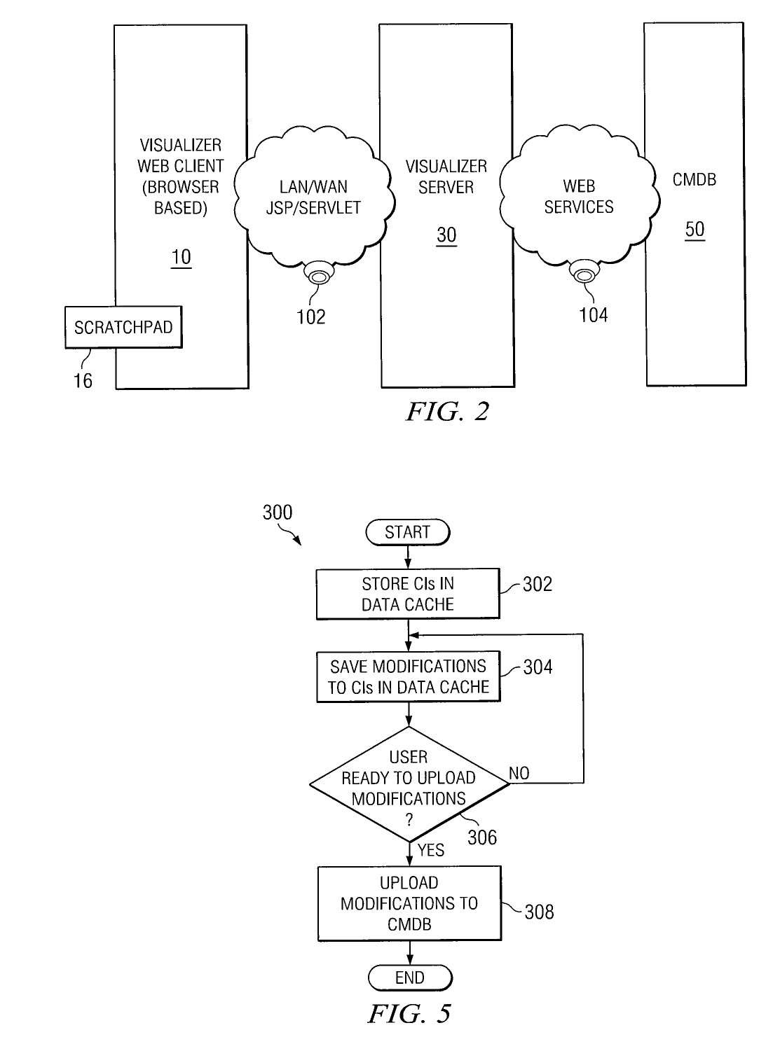

FIG. 2 is a schematic diagram illustrating relationships between a CMDB 50 and visualizer components 10 and 30, according to particular embodiments of the present disclosure. As described above with reference to FIG. 1, visualizer client 10 may be connected to visualizer server 30, which may in turn be connected to CMDB 50.

Visualizer client 10 may include any medium for accomplishing electronic communication to a user. In the illustrated embodiment, client 10 is represented by a browser-based visualizer web client and includes a local cache or “scratchpad” 16. Although the client is illustrated as a browser-based web client, in alternative embodiments, client 10 may not be browser-based. Visualizer client 10 may be connected to visualizer server 30 by virtually any communication system that allows communication between the two components. For instance, in the illustrated embodiment, this commnunication system may be a LAN or WAN using a Java Servlet application programming interface (API). However, in alternative embodiments, different communication systems and/or interfaces may be used to connect visualizer client 10 and visualizer server 30. In still alternative embodiments, visualizer client 10 may reside locally on visualizer server 30.

Visualizer server 30 may refer to any device that is operable to deliver information that is sent to the client system 10. CMDB 50 may be a database that contains relevant information about components used in an organization's IT services, as well as the relationships between those components. Server 30 and CMDB 50 may be positioned separately, or in alternative embodiments, CMDB 50 may be positioned within server 30. Regardless of their positioning, visualizer server 30 and CMDB 50 communicate between one another. This communication may be accomplished using virtually any communication technique. According to the illustrated embodiment, they may communicate using Web Services.

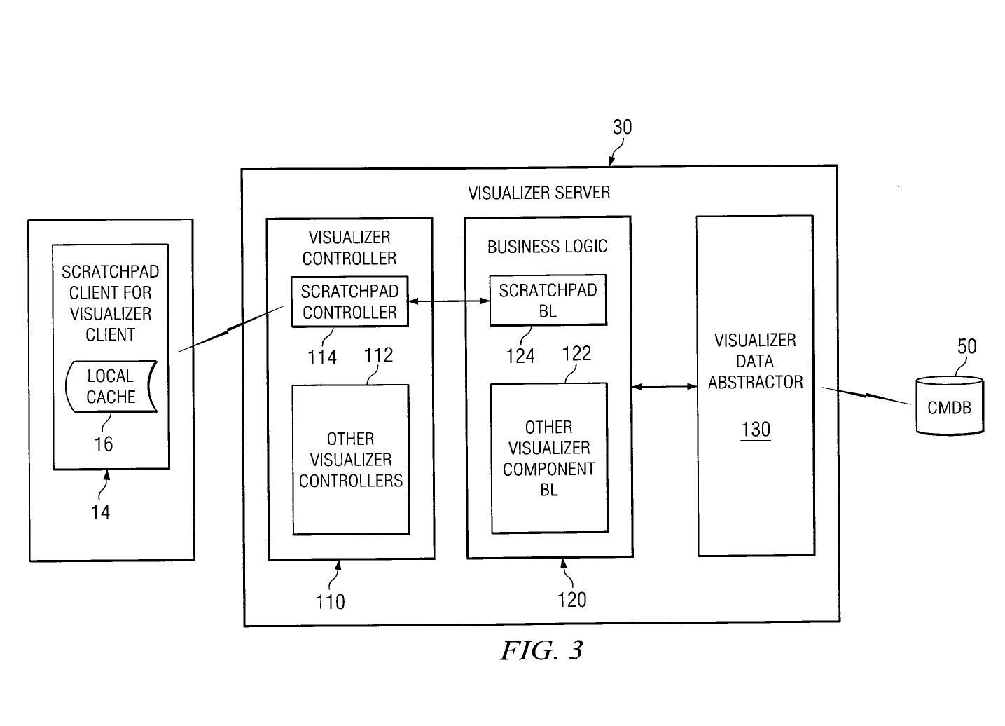

FIG. 3 is a schematic diagram illustrating relationships between a CMDB 50 and visualizer components 10 and 30, according to particular embodiments of the present disclosure.

Visualizer client 10 comprises a scratchpad client 14 and local data cache 16. In particular embodiments, scratchpad client 14 may comprise a browser that allows standardized communication with visualizer server 30. Local data cache 16 may allow for storage of configuration items from a CMDB.

Visualizer server 30 may refer to any device that is operable to deliver information that is sent to a client system. According to the illustrated embodiment, visualizer server 30 comprises visualizer controller 110, business logic 120, and visualizer data abstractor 130.

Visualizer controller 110 may comprise scratchpad controller 114, as well as other visualizer controllers 112. In general, controller 110 serves to interface with external devices, such as client system 10. In alternative embodiments, controller 110 may also interface with devices that reside locally on server 30. In the illustrated embodiment, a specific scratchpad controller 114 is illustrated for interfacing with scratchpad client 14. Additional visualizer controllers 112 may be provided to interface with additional components of client system 10, or even additional client systems. In alternative embodiments, one controller may be relied on to interface with multiple components of a single client system or multiple client systems.

Business logic 120 may comprise scratchpad business logic 124, as well as other visualizer component business logic 120. In general, business logic 120 may work to expose interfaces between client system 10, visualizer server 30, and CMDB 50. In doing so, the business logic 120 may define how data is abstracted from various sources, such as CMDB 50. According to particular embodiments, Web Services may be used to abstract the data. In particular embodiments, the scratchpad business logic 124 may also interface with scratchpad controller 114 to facilitate synchronizing of scratchpad data with CMDB 50. In the illustrated embodiment, additional visualizer component business logics 122 are shown. These may expose interfaces between other visualizer components, such as additional visualizer controllers 112. However, in alternative embodiments controllers may be combined into a single controller 110, and business logics may be combined into a single business logic 120.

Visualizer data abstractor 130 may comprise a data access layer capable of implementing interfaces exposed by the business logic. In alternative embodiments, data abstractor 130 and business logic 120 may be combined into a single element. However, separating the elements may allow changes to be made to the data abstractor 130 without affecting the business logic 120.

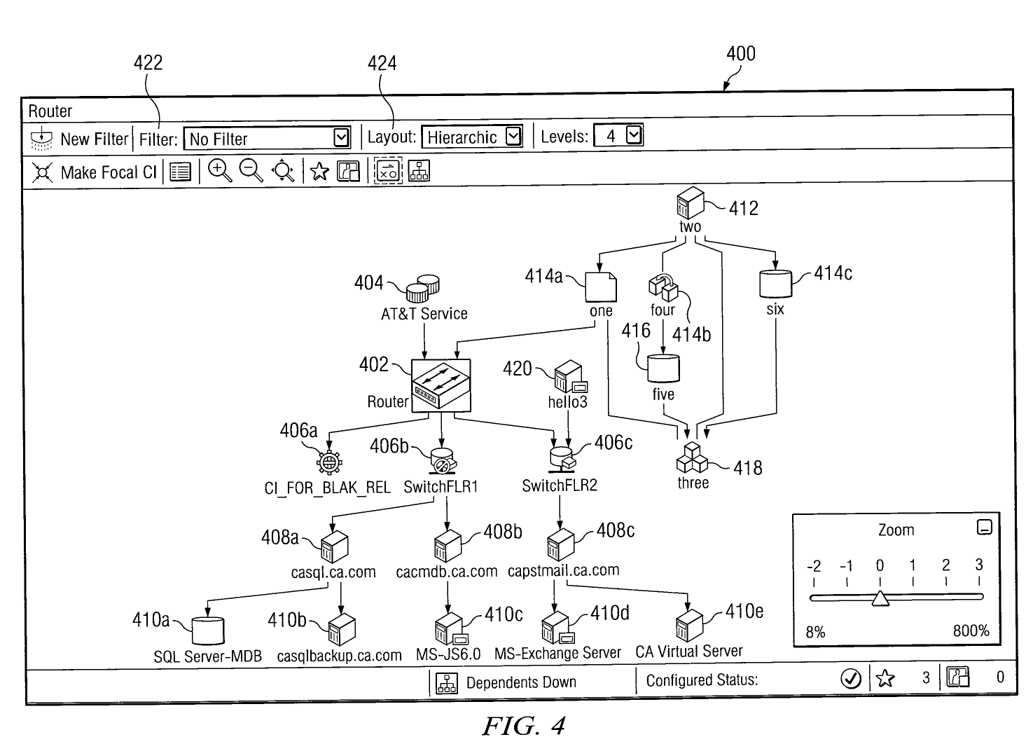

FIG. 4 is a schematic drawing illustrating a CMDB graphical display presentation 400, according to particular embodiments of the present disclosure. According to the illustrated embodiment, multiple configuration items, as well as their inter-relationships, are displayed to the user. In the illustrated embodiment, the presentation focuses on router 402. According to the illustrated embodiment, this may be referred to as the “focal configuration item” or “focal CI.” This focus in the illustrated embodiment is designated by enlarging the icon for router 402 and surrounding it with a box. In alternative embodiments, focal CIs may be designated by various visual cues, or no visual cues at all. Although the illustrated embodiment depicts one focal CI, in alternative embodiments there may be zero or more than one focal CI.

Various other configuration items, represented by reference numerals 404, 406, 408, 410, 412, 414, 416, 418, and 420 are also displayed, along with their relationship to router 402. These configuration items may be virtually any IT component, including but not limited to software, hardware, documentation, personnel, or any combination thereof. Many configuration items may be predefined. According to particular embodiments, a user may create still more configuration items by defining various attributes. Whether predefined or user-created, these items may take the form of graphical icons, text boxes, or any other method of easily conveying to a user the name and content of the item. According to the illustrated embodiment, various icons are used to represent the different types of configuration items. Text below the icons may provide the names and/or other descriptive information concerning a particular item. In alternative embodiments, the arrows connecting each configuration item may provide information concerning the relationships between the configuration items. For instance, these relationships may include, but are not limited to “connected to,” “depends from,” “is used by,” and “runs.”

Although numerous items are displayed in the illustrated embodiment, alternative embodiments may comprise fewer or more configuration items and relationships. The method of displaying these items may also be customizable by a user. For instance, the illustrated embodiment portrays a hierarchical layout. In alternative embodiments, the layout may be displayed in a circular form, or any other fashion that may facilitate the visual display of relationships among the configuration items. A user may select which layout to use. According to the illustrated embodiment, this may be accomplished using a layout pull-down menu 424. A user may also select to filter information using the list of filters 422. A user may use the layout selection tool 424, filter selector 422, and various other tools to customize the display 400. This may lead to one connected graph, as shown in the illustrated embodiment. Alternatively, various graphs that are either interrelated or disjointed may be displayed.

FIG. 5 is a flow diagram illustrating a method for using a configuration management database according to particular embodiments of the present disclosure. The specific steps of FIG. 5 will be described in detail below with reference to elements illustrated in FIGS. 1-4.

The process begins at step 302, where configuration items are stored in a data cache 16. Configuration items may be a collection of objects related to the functionality of a system. These objects may include, but are not limited to files, code, requirements, or other documentation. Configuration items may typically form the basis of configuration management solutions, such as configuration management database 50.

Many configuration items may be stored in CMDB 50. According to particular embodiments, CMDB 50 may automatically discover, inventory, and store data relating to configuration items and the relationships between configuration items. Oftentimes, the CMDB may be populated by thousands or more configuration items. Nevertheless, a user or operator may only work with or be concerned with a much smaller set of configuration items. Traditionally, whenever a user wished to work with these configuration items, he or she would have to log on to the CMDB 50 and browse or search for the desired configuration items before working with them. According to the teachings of the present disclosure, a user may now search for desired configuration items and store them in data cache 16. Accordingly, whenever the user wishes to access or work on one of these configuration items, they may be accessed directly from data cache 16, without having to search or retrieve them from CMDB 50. This may provide for more efficient access to configuration items, especially when a user has a set of “favorites” or commonly-used configuration items.

Additionally, some configuration items may not be stored in CMDB 50. This may be a result of the format of certain configuration items. For instance, certain configuration items may not be subject to auto discovery by CMDB 50. In these instances, a user may discover the configuration item. Alternatively, a user may wish to generate a new configuration item that is not stored in CMDB 50.

Regardless of the format or origin of a configuration item, a user may then store any of these commonly-used configuration items in data cache 16. According to particular embodiments, this may comprise saving primary attributes of a configuration item. These primary attributes are the basic attributes that describe a configuration item and may vary from one CI type to another. Generally, these may include, but are not limited to a CI ID that identifies the particular configuration item and a CI Type ID that identifies the type of configuration item. The primary attributes may also include information about relationships a particular configuration item has with other configuration items. In particular embodiments, such as a server CI type, the primary attributes may include, but are not limited to unique machine identifier, vendor type, and IP address. In alternative embodiments, such as a service CI type, the primary attributes may include, but are not limited to service level agreement (SLA) and service type. In addition to storing information about the configuration items themselves, information regarding relationships between the various configuration items may also be stored in data cache 16.

Once configuration items are stored in data cache 16, a user may perform operations, such as modifications, on these configuration items. At step 304, these modifications are stored locally in the data cache 16 as well. This may allow a user to perform modifications locally before committing the changes to CMDB 50. These modifications may include, but are not limited to changes to existing configuration items or relationships, deletion of configuration items or relationships, or addition of new configuration items or relationships. This may allow a user to make modifications to an entire set of related configuration items, and then upload all of the changes at once to CMDB 50. Additionally, a user may work on one or more local configuration items over multiple work sessions, without having to submit the changes to CMDB 50 each time a work session is ended. This may prevent introduction of incomplete work to CMDB 50 or the production environment. For these reasons, data cache 16 may be referred to as a “scratchpad,” as it allows a user to brainstorm, test ideas, and perform modifications without permanently committing them to a CMDB.

According to particular embodiments, a user may choose to manually save any modifications within data cache 16. According to alternative embodiments, modifications may automatically be saved within data cache 16, for instance when a user ends a work session. Data cache 16 may also be user-specific. This means that each individual only has access to his or her own scratchpad that is accessed whenever that particular user logs on to CMDB 50. According to alternative embodiments, data cache 16 may be shared among multiple users. This may allow more than one user, such as a team, to work on the same set of commonly-used configuration items.

According to particular embodiments, modifications may be made using a form layout. This layout may be an editable form providing information about a configuration item. According to particular embodiments, each form may only represent one configuration item. Therefore, modifications may be made to each configuration item one at a time using this form layout.

According to alternative embodiments, a graphical display, such as CMDB visualizer 400, may be employed. Visualizer 400 may be used as an alternative to, or in conjunction with a traditional form layout. In the illustrated embodiment, a simplified graphical display is shown. It should be appreciated that visualizer 400 may encompass many different graphical displays showing configuration items and their relationships. According to particular embodiments, this may be accomplished using graphical dependency trees. For instance, in the illustrated example, elements 406, 408, and 410 all depend from an router 402. At the same time, router 402 depends from element 404. These elements may include, but are not limited to, additional servers, applications, routers, services, database files, or user elements. Additionally, users may create their own types of configuration items. Regardless of the exact format of visualizer 200, it may provide an easy overview of IT infrastructure to a user. Additionally, a user may pan, zoom, or select certain elements for more detailed views.

According to particular embodiments, visualizer 200 may function as a read-only tool. This means that when a user searches CMDB 50, the results may be returned to the user in graphical format 200. Alternatively, visualizer 200 may also be used to search or browse CMDB 50. However, in a read-only format, the user may not make any changes or modifications to the graphical display. In these embodiments, the user may still download one or more configuration items to data cache 16, and make changes there. These modifications may be made using a form layout. Once the user has completed these modifications and uploaded them to CMDB 50, the changes may be reflected in visualizer 200.

According to alternative embodiments, visualizer 200 may be a fully functional graph modeling tool. This means that a user may not only use visualizer 200 to view configuration items and their relationships, but may also make modifications to configuration items and their relationships using the graphical display. For instance, a user may click directly on a given element, such as application server 202, and be presented with a list of attributes that may be modified. Additionally, a user may “drag-and-drop” various elements in the display. This may be particularly helpful when adding, deleting, or modifying relationships between configuration items.

The ability to modify configuration items directly in visualizer 200 may allow a user to more easily understand a larger IT infrastructure and make modifications to more than one configuration item at a time. According to particular embodiments, when configuration items are stored in data cache 16, they may be stored in a graphical format, such as visualizer 200. Therefore, all changes made locally in the graphical display will not initially be reflected in CMDB 50.

At a certain time, all modifications to the one or more configuration items stored in data cache 16 may be complete. Thus, at step 306, the user decides if he or she is ready to upload the configuration items to the CMDB 50. If the user is not prepared to do this, the configuration items will simply remain in data cache 16. This may be because all the desired modifications have not been performed. Alternatively, this may be because some configuration items have been modified, but other related items have not. In these particular situations, the user may wish to upload the modified, related configuration items all at once. Regardless of the reason, the configuration items may remain stored in data cache 16 until the user wishes to upload them to CMDB 50.

At step 308, if the user wishes to do so, he or she may upload the modified or new configuration items into the CMDB 50. According to particular embodiments, this may require an affirmative action by the user to upload the items to synchronize with the CMDB 50. In particular embodiments, this may be accomplished during a work session by selecting an option to upload the configuration items. According to alternative embodiments, the user may also be prompted to upload the modified configuration items each time he or she intends to end a work session by logging out of CMDB 50. The uploaded items may comprise one or more configuration items. In particular embodiments, the user may simply wish to upload one new or modified configuration item. In alternative embodiments, the user may choose to upload multiple new or modified configuration items at once. According to particular embodiments, after the configuration items are uploaded to CMDB 50, they may be deleted from data cache 16.

It should be understood that some of the steps illustrated in FIG. 3 may be combined, modified, or deleted where appropriate, and additional steps may also be added to the flow diagram.

In addition to the advantages enumerated above, various embodiments of the present disclosure provide other benefits. In general, the method of the present disclosure may allow for local access to frequently-used configuration items. In particular embodiments, this may allow for more efficient operations on configuration items. Additionally, the method may prevent incomplete updates from being introduced into a CMDB production environment. Various other advantages may be readily apparent to one having skill in the art.

Although the present invention has been described in detail, it should be understood that various changes, substitutions, and alterations can be made without departing from the spirit and scope of the invention as defined by the appended claims.

What is claimed is:

1. A method, comprising:
storing one or more configuration items in a local data cache, wherein a user may access the one or more configuration items from the local data cache without retrieving the one or more configuration items from a configuration management database;
saving modifications made, by the user, to the one or more configuration items, in the local data cache; and
uploading the one or more modified configuration items to the configuration management database.

2. The method of claim 1, further comprising:
generating one or more new configuration items in the local data cache; and
uploading the one or more new configuration items to the configuration management database.

3. The method of claim 1, wherein the modifications comprise modifications to relationships between the one or more configuration items.

4. The method of claim 1, wherein uploading the one or more modified configuration items comprises receiving an instruction, from the user, that the one or more configuration items is prepared for uploading.

5. The method of claim 1, further comprising presenting the one or more configuration items and relationships between the configuration items in a graphical display.

6. The method of claim 5, wherein the user may modify or add configuration items using the graphical display.

7. A system, comprising:
a local data cache being operable to store one or more configuration items, wherein a user may access the one or more configuration items from the local data cache without retrieving the one or more configuration items from a configuration management database;
a user interface being operable to receive modifications, made by the user, to the one or more configuration items;
the local data cache being operable to save the modifications made by the user; and
the configuration management database operable to receive one or more modified configuration items uploaded by the user.

8. The system of claim 7, wherein the local data cache is further operable to generate one or more new configuration items and wherein the configuration management database is further operable to receive the one or more new configuration items uploaded by the user.

9. The system of claim 7, wherein the modifications comprise modifications to relationships between the one or more configuration items.

10. The system of claim 7, wherein the user interface is further operable to receive an instruction, from the user, that the one or more configuration items is prepared for uploading.

11. The system of claim 7, wherein the user interface is further operable to present the one or more configuration items and relationships between the configuration items in a graphical display.

12. The system of claim 11, wherein the user may modify or add configuration items using the graphical display.

13. Logic encoded in a computer readable medium and being operable, when executed on a processor, to:
store one or more configuration items in a local data cache, wherein a user may access the one or more configuration items from the local data cache without retrieving the one or more configuration items from a configuration management database;
save modifications made, by the user, to the one or more configuration items, in the local data cache; and
upload the one or more modified configuration items to the configuration management database.

14. The logic of claim 13, wherein the logic is further operable to:
generate one or more new configuration items in the local data cache; and
upload the one or more new configuration items to the configuration management database.

15. The logic of claim 13, wherein the modifications comprise modifications to relationships between the one or more configuration items.

16. The logic of claim 13, wherein the logic is further operable to receive an instruction, from the user, that the one or more configuration items is prepared for uploading.

17. The logic of claim 13, wherein the logic is further operable to present the one or more configuration items and relationships between the configuration items in a graphical display.

18. The logic of claim 17, wherein the user may modify or add configuration items using the graphical display.
